(19) United States
(12) Patent Application Publication
(10) Pub. No.: US 2026/0061232 A1
(43) Pub. Date: Mar. 5, 2026

(54) Industrial System and Method of Controlling Industrial System

(71) Applicant: ABB Schweiz AG, Baden (CH)

(72) Inventors: Piotr Stasiak, Bryne (NO); Bjarne Sandvik, Bryne (NO)

(73) Assignee: ABB Schweiz AG, Baden (CH)

(21) Appl. No.: 19/385,308

(22) Filed: Nov. 11, 2025

Related U.S. Application Data
(63) Continuation of application No. PCT/EP2023/063263, filed on May 17, 2023.

(51) Int. Cl. A62C 3/00; B25J 19/06

(52) U.S. Cl. CPC A62C 3/00; B25J 19/06

(57) ABSTRACT

An industrial system includes an industrial actuator including a primary compartment containing a primary electric device and a secondary compartment containing a secondary electric device; a pressure system generating an overpressure in the primary compartment and in the secondary compartment with respect to the exterior region; a power line for supplying electric power to each primary electric device and each secondary electric device; a primary switch provided on the power line arranged to selectively connect and disconnect power supply to each primary electric device and each secondary electric device; and a secondary switch provided on the power line arranged to selectively connect and disconnect power supply to each secondary electric device, the secondary switch being positioned inside the primary compartment.

### CROSS-REFERENCE TO RELATED APPLICATIONS

The instant application claims priority to International Patent Application No. PCT/EP2023/063263, filed May 17, 2023, which is incorporated herein in its entirety by reference.

### FIELD OF THE DISCLOSURE

The present disclosure generally relates to explosion protection of an industrial actuator and, more particularly, to an industrial system comprising an industrial actuator including a primary compartment, a secondary compartment and a pressure system, and a method of controlling such industrial system, are provided.

### BACKGROUND OF THE INVENTION

In order to enable an industrial actuator to operate in an explosive environment, an enclosure of the industrial actuator may be purged and pressurized. Purging of the enclosure typically comprises introducing non-explosive gas, such as air or nitrogen, into the enclosure such that any explosive gas is flush out from the enclosure. Such purging may comprise at least five changes of the gas within a total volume the enclosure. Thus, a minimum volume of five times the enclosure volume may be led into the enclosure, and a minimum volume of five times the enclosure volume may be led out from the enclosure. In this way, the enclosure is purged and the enclosure volume is exchanged at least five times. By purging the enclosure, it can be ensured that any explosive gas inside the enclosure is removed prior to supplying electric power to electric devices within the enclosure.

By pressurizing the enclosure to a positive pressure relative to an exterior pressure of the environment, ingress of explosive gas into the enclosure from the environment is prevented. The positive pressure or overpressure may for example be 0.5 mbar. Once the enclosure is purged and pressurized, electric devices within the enclosure will not be exposed to explosive gas and can therefore be safely operated.

US 4985653 A relates to an internal pressure explosion-proof construction for an electrically driven robot. A space within the robot is divided into a plurality of chambers, where each chamber includes one motor. The chambers are in turn grouped into three larger blocks, and each block can be purged independently from the other blocks. The robot comprises six parallel power lines for powering the motors.

EP 0187865 B1 discloses an industrial robot comprising a stationary base unit, a swiveling body unit, an upper arm, a lower arm and a wrist unit. A working attachment such as a robot hand or the like can be attached to the wrist unit. Airtight chambers are formed in the interior of the stationary base unit, the swiveling body unit, and the upper arm, respectively. The airtight chambers are connected to a pressurized air supply source by means of an air pipe.

WO 2012007188 A1 discloses a robot comprising a tool changer configured to receive and withdraw a tool. The tool changer is adapted for operating in an explosive environment by providing a switch for switching on and off a supply of electrical power to the tool, and by arranging the switch within a purge area. By arranging the switch within the purge area, an electric circuit which supplies electrical power to the tool can be closed within the purge area.

US 2008287050 A1 refers to an explosion protection system for electrical apparatuses and machineries, such as manipulators or industrial robots, located in hazardous environments, i.e. environments containing explosive concentrations of inflammable gases, dusts or vapors, comprising an air supply that applies internal pressurized air into an explosion proof enclosure. A flow- and pressure sensor is arranged as an integrated unit.

### BRIEF SUMMARY OF THE INVENTION

In US 4985653 A, a dedicated power line is used for each chamber. This requires excessive cabling and complicated routing of the cabling. Moreover, a switch is required for each power line in order to disconnect a power supply to the respective motor. Thus, a plurality of switches have to be operated to connect and disconnect power supply to a plurality of motors. Although explosive gas is said to be prevented from entering the construction, it may be desirable to reduce the number of switches operated within the construction to increase safety. In one aspect, the present disclosure provides an improved industrial system, and an improved method of controlling an industrial system.

Providing an industrial actuator comprising a primary compartment, a secondary compartment and a power line arranged to supply electric power to an electric device in each compartment, and by providing a secondary switch in the primary compartment for selectively connecting and disconnecting all secondary electric devices in the secondary compartment, downstream of the primary compartment, all downstream secondary electric devices can be disconnected using a single secondary switch. Cabling can thereby be significantly reduced and simplified, and safety is increased.

According to a first aspect, there is provided an industrial system comprising an industrial actuator including a primary compartment containing at least one primary electric device and a secondary compartment containing at least one secondary electric device; a pressure system configured to generate an overpressure in the primary compartment with respect to an exterior region outside of the industrial actuator, and to generate an overpressure in the secondary compartment with respect to the exterior region; a power line for supplying electric power to each primary electric device and each secondary electric device; and a primary switch provided on the power line arranged to selectively connect and disconnect power supply to each primary electric device and each secondary electric device. The industrial system further comprises a secondary switch provided on the power line arranged to selectively connect and disconnect power supply to each secondary electric device, the secondary switch being positioned inside the primary compartment.

### BRIEF DESCRIPTION OF THE SEVERAL VIEWS OF THE DRAWINGS

FIG. 1 is a side view of an industrial system in accordance with the disclosure.

FIG. 2 is a diagram of an industrial system in accordance with the disclosure.

FIG. 3 is a cross-sectional view of a power line in accordance with the disclosure.

FIG. 4 is a diagram of an additional industrial system in accordance with the disclosure.

### DETAILED DESCRIPTION OF THE INVENTION

In the following, an industrial system comprising an industrial actuator including a primary compartment, a secondary compartment and a pressure system, and a method of controlling such industrial system, will be described. The same or similar reference numerals will be used to denote the same or similar structural features.

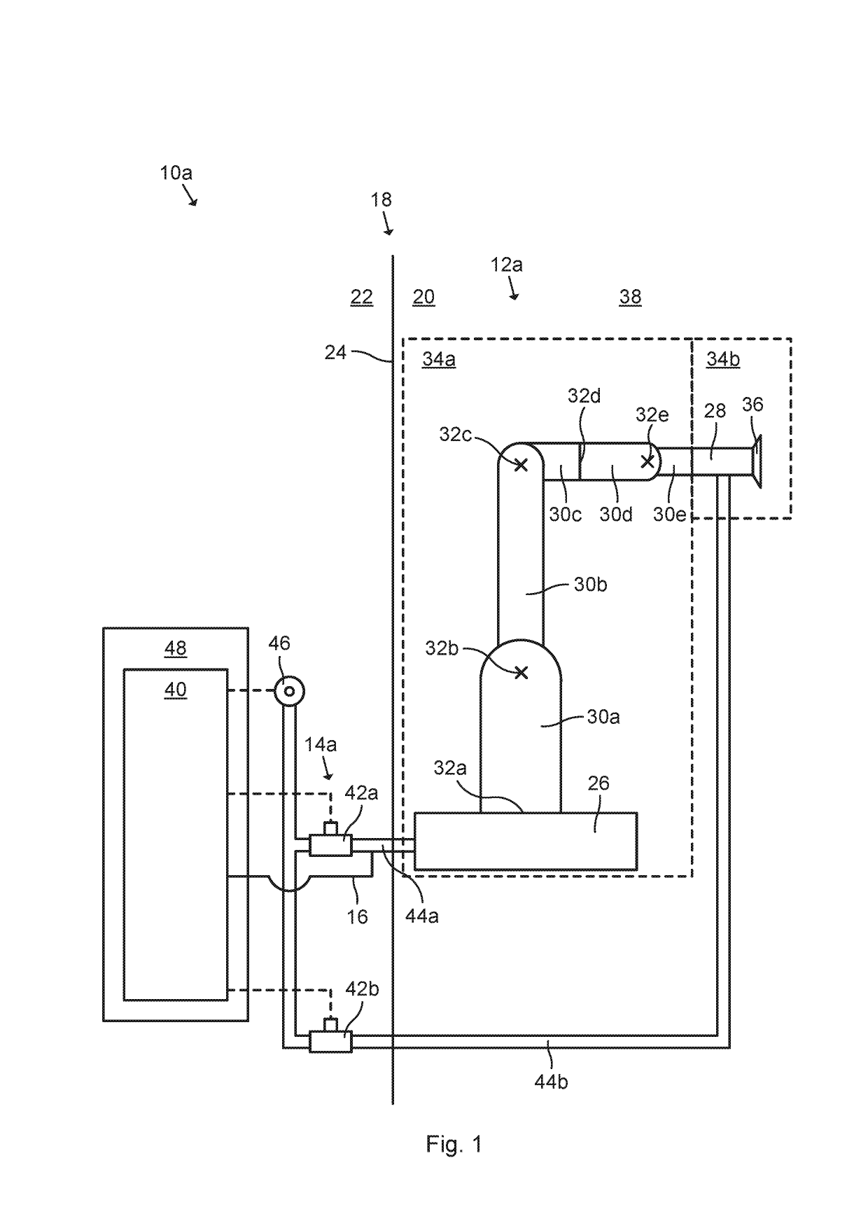

FIG. 1 schematically represents a side view of an industrial system 10a. The industrial system 10a comprises an industrial robot 12a, a pressure system 14a and a power line 16. The industrial system 10a is arranged in an environment 18 including a hazardous region 20 and a non-hazardous region 22, here separated by a wall 24. The hazardous region 20 is an explosive region and the non-hazardous region 22 is a non-explosive region.

The industrial robot 12a is one example of an industrial actuator according to the present disclosure. As shown in FIG. 1, the industrial robot 12a is positioned entirely in the hazardous region 20. The industrial robot 12a of this specific and non-limiting example comprises a base 26, an attachment 28, a first link 30a rotatable relative to the base 26 at a first joint 32a, a second link 30b rotatable relative to the first link 30a at a second joint 32b, a third link 30c rotatable relative to the second link 30b at a third joint 32c, a fourth link 30d rotatable relative to the third link 30c at a fourth joint 32d, and a fifth link 30e rotatable relative to the fourth link 30d at a fifth joint 32e. The fifth link 30e comprises an interface (not denoted) to which the attachment 28 is connected.

The industrial robot 12a of this example comprises a primary compartment 34a and a secondary compartment 34b, as schematically shown in FIG. 1. The secondary compartment 34b is arranged distal of the primary compartment 34a. In this example, an enclosure formed by the base 26 and each of the links 30a-30e constitutes the primary compartment 34a, and an enclosure of the attachment 28 constitutes the secondary compartment 34b. A volume of the primary compartment 34a may for example be 100-300 liters. A volume of the secondary compartment 34b may for example be 3-15 liters. The primary compartment 34a is thus substantially larger than the secondary compartment 34b in this example.

A boundary between the compartments 34a, 34b is here formed at the interface between the fifth link 30e and the attachment 28. In the primary compartment 34a of this example, the base 26 is in fluid communication with the fifth link 30e through the links 30a-30d.

The attachment 28 may be an end effector. In FIG. 1, the attachment 28 is exemplified as a coating apparatus for applying a coating medium to an object, such as a bell atomizer comprising a rotatable bell cup 36.

FIG. 1 further shows an exterior region 38 outside of the industrial robot 12a. The exterior region 38 is a region of the hazardous region 20 outside of the compartments 34a, 34b.

The industrial system 10a further comprises a control system 40. The control system 40 is configured to control the industrial robot 12a and the pressure system 14a. The power line 16 is led from the control system 40 to the industrial robot 12a.

The pressure system 14a of this example comprises a primary valve device 42a, a primary air line 44a, a secondary valve device 42b and a secondary air line 44b. The primary air line 44a is connected between the primary valve device 42a and the primary compartment 34a, here to the base 26. The secondary air line 44b is connected between the secondary valve device 42b and the secondary compartment 34b. Each of the valve devices 42a, 42b is positioned in the non-hazardous region 22. Each of the air lines 44a, 44b passes through the wall 24 from the non-hazardous region 22 into the hazardous region 20. As illustrated in FIG. 1, the power line 16 enters the primary air line 44a in the non-hazardous region 22. Thus, in the hazardous region 20, the power line 16 is led inside the primary air line 44a to the industrial robot 12a.

The industrial system 10a further comprises a pressure source 46, such as a compressor. By controlling the primary valve device 42a, pressurized gas from the pressure source 46 is led through the primary air line 44a into the primary compartment 34a. By controlling the secondary valve device 42b, pressurized gas is led through the secondary air line 44b into the secondary compartment 34b. To this end, the valve devices 42a, 42b are controlled by the control system 40. The pressure source 46 may also be controlled by the control system 40. By means of the pressure system 14a, each of the compartments 34a, 34b can be independently purged and pressurized with respect to the exterior region 38 to thereby provide electrical safety. The industrial system 10a of this example further comprises a cabinet 48. The control system 40 is provided inside the cabinet 48.

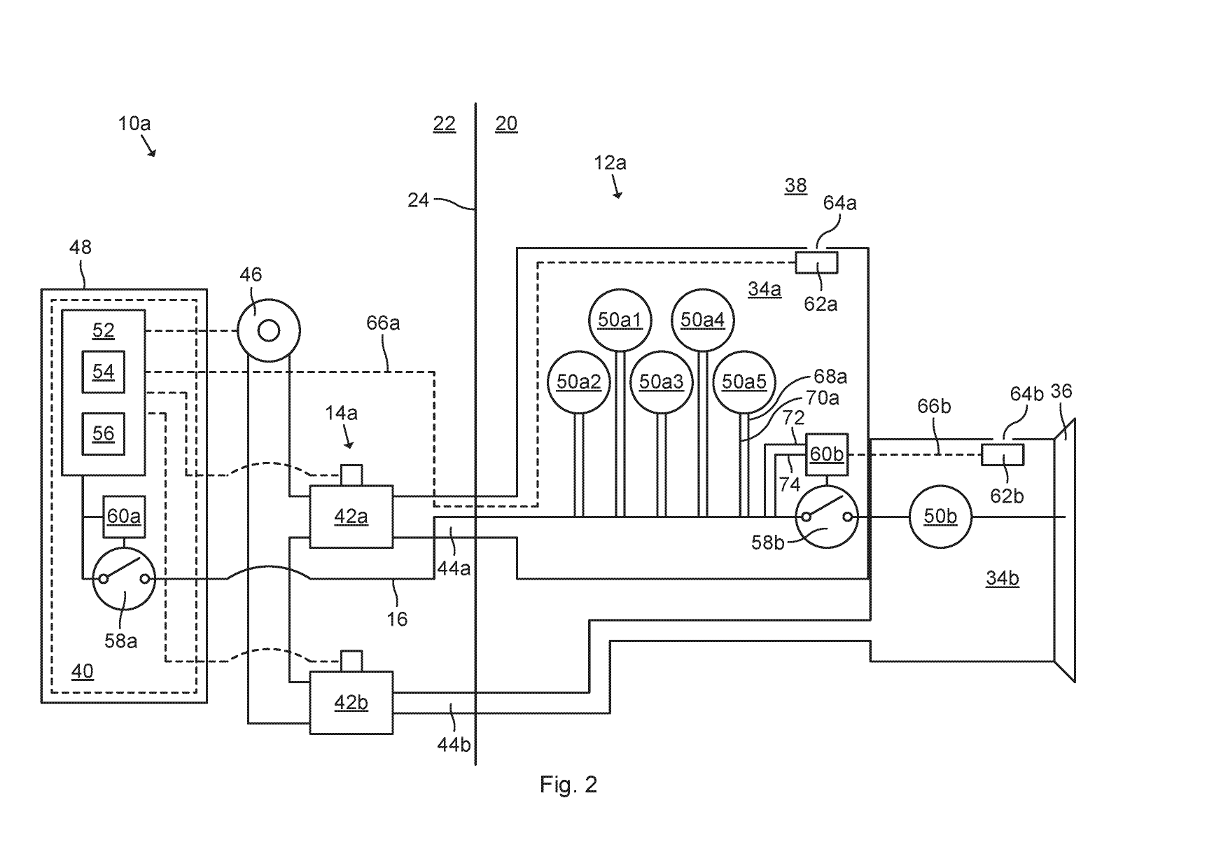

FIG. 2 is a diagrammatic representation of the industrial system 10a. In FIG. 2, more details of the industrial system 10a are shown. The industrial robot 12a of this example comprises a plurality of primary electric motors arranged within the primary compartment 34a, here a first primary electric motor 50a1 for driving the first joint 32a, a second primary electric motor 50a2 for driving the second joint 32b, a third primary electric motor 50a3 for driving the third joint 32c, a fourth primary electric motor 50a4 for driving the fourth joint 32d, and a fifth primary electric motor 50a5 for driving the fifth joint 32e. One, several or all of the primary electric motors 50a1-50a5 may also be referred to with reference numeral "50a". The primary electric motors 50a are examples of primary electric devices according to the present disclosure.

The industrial robot 12a of this example further comprises a secondary electric motor 50b arranged within the secondary compartment 34b. In this specific example, the secondary electric motor 50b is arranged to drive rotation of the bell cup 36. The secondary electric motor 50b is one example of a secondary electric device according to the present disclosure.

The control system 40 of this example comprises a main controller 52. The main controller 52 comprises a data processing device 54 and a memory 56. The memory 56 has a computer program stored thereon. The computer program comprises program code which, when executed by the data processing device 54, causes the data processing device 54 to perform, or command performance of, various steps as described herein.

The industrial system 10a further comprises a primary switch 58a and a secondary switch 58b. The industrial system 10a further comprises a primary switch controller 60a for controlling the primary switch 58a and a secondary switch controller 60b for controlling the secondary switch 58b. As shown in FIG. 2, the secondary switch 58b, and here also the secondary switch controller 60b, are positioned inside the primary compartment 34a. Since the secondary switch controller 60b is positioned inside the primary compartment 34a, the secondary switch controller 60b is a further example of a primary electric device according to the present disclosure.

The primary switch 58a and the primary switch controller 60a are positioned in the non-hazardous region 22. In this example, the primary switch 58a and the primary switch controller 60a form part of the control system 40 and are thus also positioned inside the cabinet 48.

Since the primary switch 58a is positioned in the non-hazardous region 22 and the primary compartment 34a is positioned in the hazardous region 20, the primary switch 58a is positioned upstream of the primary compartment 34a. The secondary switch 58b positioned in the primary compartment 34a is thus positioned in a compartment upstream of the secondary compartment 34b. Thus, in the industrial system 10a, the compartments 34a, 34b are arranged in series and each switch 58a, 58b is arranged upstream of its respectively associated compartment 34a, 34b. The industrial system 10a may therefore be said to constitute a cascade purging system.

Each of the switches 58a, 58b is provided on the power line 16. The secondary switch 58b is positioned downstream of the primary switch 58a. The secondary switch 58b is therefore powered by a voltage protected by the primary switch 58a. When both switches 58a, 58b are closed, the power line 16 supplies electric power, here from the main controller 52, to each primary electric motor 50a, the secondary switch controller 60b and the secondary electric motor 50b. When the primary switch 58a is open, electric power supply to all primary electric motors 50a, the secondary switch controller 60b and the secondary electric motor 50b is disconnected regardless of the state of the secondary switch 58b. When the primary switch 58a is closed and the secondary switch 58b is open, the power line 16 supplies electric power to all primary electric motors 50a and the secondary switch controller 60b, but not to the secondary electric motor 50b. In view of this, the primary switch 58a is associated with the primary compartment 34a and the secondary switch 58b, although being positioned inside the primary compartment 34a, is associated with the secondary compartment 34b.

The industrial system 10a of this example further comprises a primary purge sensor 62a positioned in the primary compartment 34a adjacent to a primary outlet 64a thereof, and a secondary purge sensor 62b positioned in the secondary compartment 34b adjacent to a secondary outlet 64b thereof. The primary outlet 64a is arranged in an opposite region of the primary compartment 34a with respect to the primary air line 44a. Correspondingly, the secondary outlet 64b is arranged in an opposite region of the secondary compartment 34b with respect to the secondary air line 44b.

Each purge sensor 62a, 62b is configured to sense a pressure of the gas inside the respective compartment 34a, 34b and a flow of the gas out from the respective outlet 64a, 64b. The primary purge sensor 62a is in signal communication with the control system 40, here the main controller 52 thereof, via an electrically safe primary purge sensor cable 66a. Similarly to the power line 16, the primary purge sensor cable 66a passes between the hazardous region 20 and the non-hazardous region 22 inside the primary air line 44a. The secondary purge sensor cable 66b passes from the secondary switch controller 60b to the secondary purge sensor 62b.

The power line 16 of this example comprises a plurality of cables. FIG. 2 shows that the power line 16 comprises a plurality of primary motor power cables 68a. Each primary motor power cable 68a is arranged to electrically power, and thereby control, an associated primary electric motor 50a. The primary electric motors 50a may for example be powered with three-phase currents.

FIG. 2 further shows that the power line 16 of this example comprises a plurality of primary motor signal cables 70a. Each primary motor signal cable 70a is arranged to receive sensor information from one or more sensors (not shown) associated with one of the primary electric motors 50a.

FIG. 2 further shows that the power line 16 of this example comprises a controller power cable 72 and a controller signal cable 74. The controller power cable 72 electrically powers the secondary switch controller 60b, for example with a voltage of 24 V. The controller signal cable 74 is used to communicate control data between the control system 40 and the secondary switch controller 60b, including any data for the secondary purge sensor 62b. The primary motor signal cables 70a and/or the controller signal cable 74 may for example be Ethernet, CAN (controller area network) or SPI (serial peripheral interface) cables.

In order to provide electrical safety for the industrial robot 12a, the compartments 34a, 34b may be purged and pressurized. The primary compartment 34a may be purged first. After opening the primary switch 58a, the pressure system 14a is controlled to supply pressurized air into the primary compartment 34a, here by controlling the primary valve device 42a. A first, relatively high flow of pressurized gas is led into the primary compartment 34a from the primary air line 44a and exits to the exterior region 38 through the primary outlet 64a. Any explosive gas inside the primary compartment 34a is thereby flushed out. That is, the primary compartment 34a is purged. Once sufficient amount of gas has passed through the primary outlet 64a, as determined by the primary purge sensor 62a, a second, relatively low flow of pressurized gas is led into the primary compartment 34a such that an overpressure is maintained in the primary compartment 34a with respect to the exterior region 38, for example an overpressure of 0.5 mbar. The primary compartment 34a is thereby purged and pressurized. The primary switch 58a is then closed to provide power from the power line 16 to the primary electric motors 50a and the secondary switch controller 60b.

After purging and pressurizing the primary compartment 34a, the secondary compartment 34b can be purged and pressurized in a corresponding manner. The compartments 34a, 34b are thus purged in series. After purging and pressurization of the secondary compartment 34b, the secondary switch 58b is closed to provide power from the power line 16 to the secondary electric motor 50b.

After purging and pressurization of the compartments 34a, 34b, the industrial robot 12a is protected against explosions. That is, any potentially flammable gas from the exterior region 38 is prevented from entering any of the compartments 34a, 34b and is hence prevented from being ignited by any of the electric motors 50a, 50b or other electric devices therein. When the compartments 34a, 34b are purged and pressurized, the compartments 34a, 34b may be protected in accordance with the International Organization for Standardization (ISO) standard ISO 6184-2:1985.

Since the pressure system 14a of this example comprises the primary air line 44a dedicated to the primary compartment 34a and the secondary air line 44b dedicated to the secondary compartment 34b, the purging of the primary compartment 34a and the secondary compartment 34b is independent. Since the secondary switch 58b is positioned inside the primary compartment 34a, the secondary compartment 34b can be purged while the primary compartment 34a is protected and the primary electric devices therein remain operative. The ability to maintain the proximal primary compartment 34a operative during purging of the secondary compartment 34b is of great value. For example, after replacing the attachment 28 with a new attachment 28, only the relatively small secondary compartment 34b is purged while the primary compartment 34a remains purged and pressurized. The new attachment 28 may be purged simultaneously with driving the joints 32a-32e in the primary compartment 34a, e.g., to position the new attachment 28 at a target position for performing a task. The simultaneous operation of the primary electric motors 50a in the primary compartment 34a and purging of the secondary compartment 34b enables a more efficient operation.

In an alternative example, the pressure system 14a comprises a valve (not illustrated) between the primary compartment 34a and the secondary compartment 34b. In this way, pressurized air can be led into the secondary compartment 34b from the primary compartment 34a. In this example, the secondary compartment 34b is only sealingly separated from the primary compartment 34a when the valve is closed. Moreover, in this example, the secondary air line 44b may be omitted.

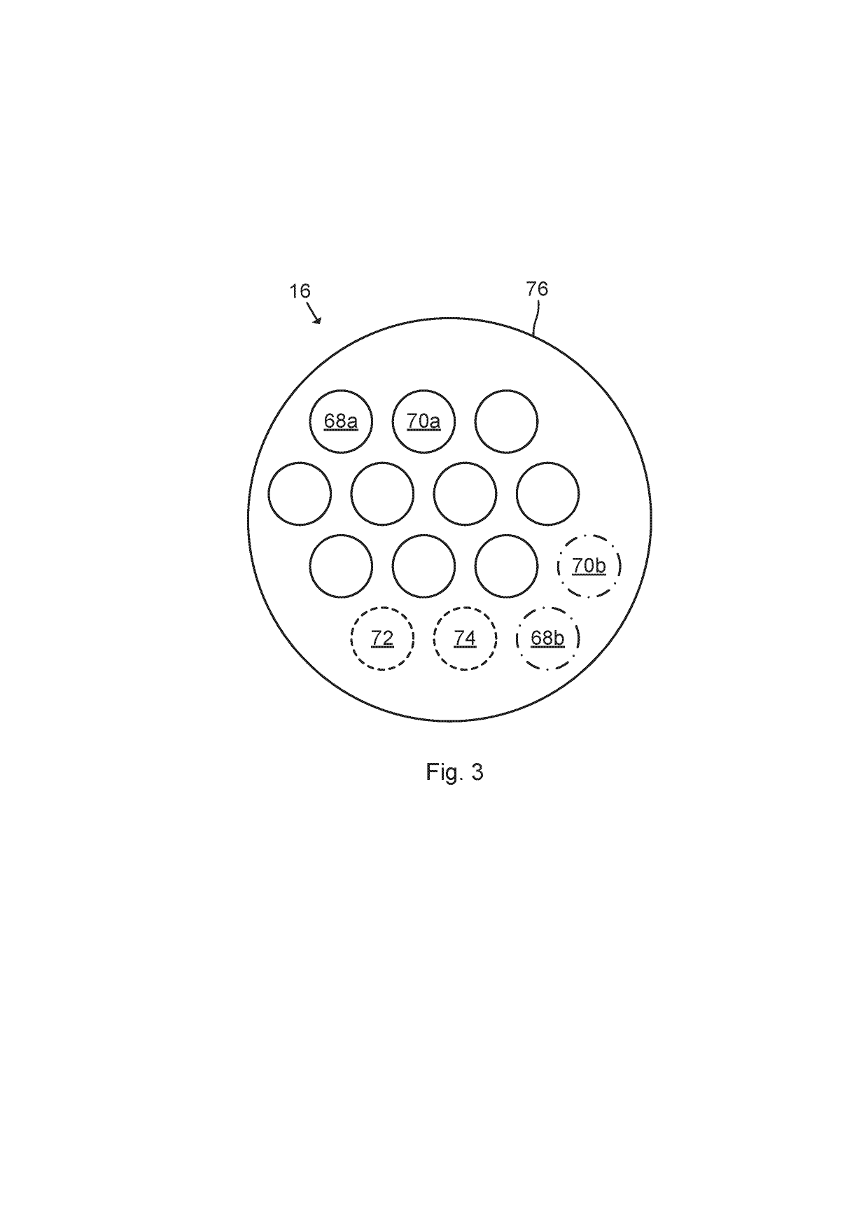

FIG. 3 schematically represents a cross-sectional view of the power line 16, such as at a position upstream of the primary compartment 34a, such as in the non-hazardous region 22. The primary motor power cables 68a and the primary motor signal cables 70a are illustrated with solid circles. The controller power cable 72 and the controller signal cable 74 are illustrated with dashed circles. FIG. 3 further shows that the power line 16 of this example comprises a secondary motor power cable 68b and a secondary motor signal cable 70b, here illustrated with dash-dotted circles. The secondary motor power cable 68b provides electric power to the secondary electric motor 50b. The secondary motor signal cable 70b provides communication data between the control system 40 and sensors associated with the secondary electric motor 50b. As shown in FIG. 3, all cables of the power line 16 are arranged in a cable harness and are here enclosed by a cover 76, such as a sleeve.

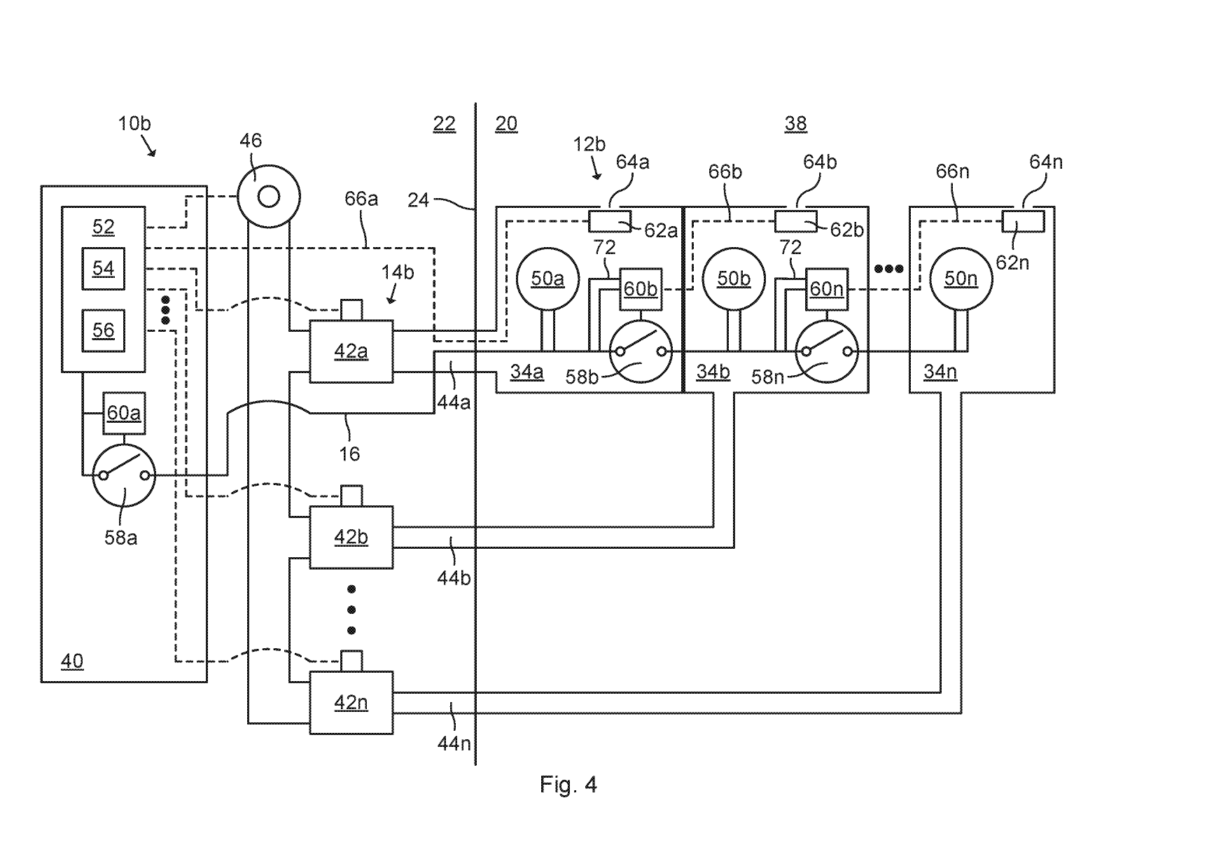

FIG. 4 is a diagrammatic representation of an industrial system 10b according to a further example. Mainly differences with respect to the industrial system 10a will be described. The industrial system 10b comprises an industrial robot 12b including n compartments, where n is an integer larger than one. The n-th compartment 34n has a design corresponding to the secondary compartment 34b of the industrial system 10b. The industrial system 10b shown in FIG. 4 comprises at least two secondary compartments, such as a first secondary compartment 34b and a second secondary compartment 34n, and at least two secondary switches, such as a first secondary switch 58b in the primary compartment 34a and a second secondary switch 58n in the first secondary compartment 34b. The industrial system 10b in FIG. 4 further comprises at least one electric device in each compartment 34a, 34b, 34n, such as a primary electric motor 50a and a primary secondary switch controller 60b in the primary compartment 34a, a first secondary electric motor 50b and a second secondary switch controller 60n in the first secondary compartment 34b, and a second secondary electric motor 50n in the second secondary compartment 34n.

The industrial system 10b in FIG. 4 further comprises a pressure system 14b including a primary valve device 42a and a primary air line 44a associated with the primary compartment 34a, a first secondary valve device 42b and a first secondary air line 44b associated with the first secondary compartment 34b, and a second secondary valve device 42n and a second secondary air line 44n associated with the second secondary compartment 34n. The industrial system 10b in FIG. 4 further comprises a primary purge sensor 62a and a primary purge sensor cable 66a associated with the primary compartment 34a, a first secondary purge sensor 62b and a first secondary purge sensor cable 66b associated with the first secondary compartment 34b, and a second secondary purge sensor 62n and a second secondary purge sensor cable 66n associated with the second secondary compartment 34n. As illustrated in FIG. 4, a single controller power cable 72 of the power line 16 is used to power each of the first secondary switch controller 60b and the second secondary switch controller 60n.

In the context of the present disclosure, in the industrial system, the secondary switch is provided on the power line between the primary switch and each secondary electric device. The secondary switch is thereby protected by the primary switch. By opening the secondary switch to disconnect power supply to each secondary electric device and maintaining the primary switch closed to provide power supply to each primary electric device, power supply can be maintained to the primary compartment while the secondary compartment is purged and pressurized by the pressure system, for example to exchange the secondary compartment. The secondary compartment may be an attachment for the industrial actuator.

The at least one primary electric device and the at least one secondary electric device are arranged in series with respect to the power line. Power supply to all primary and secondary electric devices can be connected and disconnected using the primary switch. Power supply to all secondary electric devices can be connected and disconnected using the secondary switch. The provision of the secondary switch inside the primary compartment enables cabling of the power line to be reduced.

The industrial system also provides advantages in terms of modularity. For example, in case the at least one secondary compartment comprises a first secondary compartment and a second secondary compartment, the primary compartment may contain a first secondary switch and the first secondary compartment may contain a second secondary switch. The second secondary compartment may be mechanically connected to the first secondary compartment and electrically powered via the power line such that a power supply to electric devices in the second secondary compartment can be connected and disconnected by the second secondary switch in the first secondary compartment. In this way, the second secondary compartment can be added to the industrial actuator while requiring a minimal modification of the power line. For example, the power line for the second secondary compartment may only be extended from the second secondary switch and an additional power line from a centralized control system can be avoided. The second secondary compartment may contain a third secondary switch on the power line for controlling power supply to an electric device in a potential third secondary compartment and so on. The industrial system therefore provides an improved modular design.

The pressure system may be a purge and pressurization system. Thus, the pressure system may be configured to purge and pressurize each of the primary compartment and the secondary compartment. Purging of a compartment may comprise exchanging all gas inside the compartment at least five times, such as at least ten times. The purging may comprise introducing pressurized (non-explosive) gas at a first location of the compartment and venting gas at a second location of the compartment, such as opposite to the first location. Pressurization of a compartment may comprise pressurizing the compartment to a positive pressure with respect to a pressure in the exterior region, such as to a positive pressure of at least 0.3 mbar.

The industrial system may be arranged in an environment including a hazardous region and a non-hazardous region. The industrial actuator may be arranged entirely in the hazardous region. The power line may pass from the non-hazardous region and into the hazardous region. The primary switch may be positioned in the non-hazardous region.

The hazardous region may be an explosive region containing a flammable gas. The non-hazardous region may be a non-explosive region that does not contain any flammable gas. In the environment, the hazardous region and the non-hazardous region may be separated by a wall.

The secondary compartment may be arranged downstream of the primary compartment with respect to the power line and with respect to a power source to which the power line is connected. One example of such power source is main controller of a control system according to the present disclosure. The primary compartment and the secondary compartment may thus be arranged in series with respect to the power line.

One or more of the electric devices may be an electric motor. The industrial system may further comprise a primary switch controller for controlling the primary switch and a secondary switch controller for controlling the secondary switch. The secondary switch controller may be positioned inside the primary compartment. When the secondary switch controller is positioned inside the primary compartment, the secondary switch controller is a further example of a primary electric device.

The secondary compartment may be sealingly separated from the primary compartment.

The pressure system may comprise a primary valve device and a primary air line arranged to conduct pressurized air from the primary valve device to the primary compartment. In these variants, the power line may enter the primary compartment from within the primary air line. The power line may thus enter the primary air line in the non-hazardous region. The primary valve device may be positioned in the non-hazardous region.

Optionally, the pressure system may further comprise a secondary valve device and a secondary air line arranged to conduct pressurized air from the secondary valve device to the secondary compartment. The secondary valve device may be positioned in the non-hazardous region.

The industrial system may further comprise a control system configured to control the pressure system, the primary switch and the secondary switch. The control system may be positioned in the non-hazardous region. The control system may comprise at least one data processing device and at least one memory having at least one computer program stored thereon, the at least one computer program comprising program code which, when executed by the at least one data processing device, causes the at least one data processing device to perform, or command performance of, various steps as described herein.

The industrial system may further comprise a cabinet. In these variants, the control system may comprise the primary switch, and the control system may be contained inside the cabinet.

A volume of the secondary compartment may be at least 20% smaller, such as at least 50% smaller, such as at least 90% smaller, than a volume of the primary compartment. In these variants, a purging time for purging the secondary compartment may be at least 20% shorter than a purging time for purging the primary compartment.

The power line may be a cable harness. The power line may thus comprise a plurality of cables. Examples of cables of the power line comprise power cables and signal cables for the electric devices. When any of the switches is disconnected, all cables of the power line passing through this switch are disconnected. The power line may comprise a cover enclosing all cables.

The industrial actuator may be an industrial robot, such as a painting robot. The industrial robot may comprise a manipulator programmable in three or more axes, such as in six or seven axis. To this end, the industrial robot may comprise a joint for each axis for driving distal link relative to a proximal link of the joint. Each compartment may comprise zero, only one or a plurality of links. One example of a secondary compartment for an industrial robot is an attachment, such as an end effector or other tool. Alternative types of industrial actuators may comprise feeders, conveyors and positioners.

According to a second aspect, there is provided a method of controlling an industrial system, the method comprising providing an industrial system according to the first aspect; controlling the primary switch to adopt a disconnected state; controlling the secondary switch to adopt a disconnected state; generating, by the pressure system and while the primary switch and the secondary switch are in the respective disconnected state, an overpressure in the primary compartment with respect to the exterior region; controlling, after generating the overpressure in the primary compartment, the primary switch to adopt a connected state to provide power to each primary electric device; generating, by the pressure system and while the primary switch is in the connected state, an overpressure in the secondary compartment with respect to the exterior region; and controlling, after generating the overpressure in the secondary compartment, the secondary switch to adopt a connected state to provide power to each secondary electric device.

The method may further comprise controlling, after generating the overpressure in the secondary compartment, the secondary switch to adopt the disconnected state; and physically separating the secondary compartment from the primary compartment after generating the overpressure in the secondary compartment and while the secondary switch is in the disconnected state.

The method may further comprise controlling one or more of the at least one primary electric device while the primary switch is in the connected state and the secondary switch is in the disconnected state.

As used herein, the terms distal and downstream are used interchangeably and the terms proximal and upstream are used interchangeably.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An industrial system, comprising:
an industrial actuator including a primary compartment containing at least one primary electric device and a secondary compartment containing at least one secondary electric device;
a pressure system configured to generate an overpressure in the primary compartment with respect to an exterior region outside of the industrial actuator, and to generate an overpressure in the secondary compartment with respect to the exterior region;
a power line adapted for supplying electric power to each primary electric device and each secondary electric device; and
a primary switch disposed along the power line and arranged to selectively connect and disconnect power supplied to each primary electric device and each secondary electric device; and
a secondary switch disposed along the power line and arranged to selectively connect and disconnect power supplied to each secondary electric device, the secondary switch being positioned inside the primary compartment.

2. The industrial system of claim 1, wherein the secondary compartment is sealingly separated from the primary compartment.

3. The industrial system of claim 1, wherein the pressure system comprises a primary valve device and a primary air line arranged to conduct pressurized air from the primary valve device to the primary compartment, and wherein the power line enters the primary compartment from within the primary air line.

4. The industrial system of claim 1, further comprising a control system configured to control the pressure system, the primary switch, and the secondary switch.

5. The industrial system of claim 4, further comprising a cabinet, wherein the control system comprises the primary switch, and wherein the control system is contained inside the cabinet.

6. The industrial system of claim 1, wherein a volume of the secondary compartment is at least 20% smaller than a volume of the primary compartment.

7. The industrial system of claim 1, wherein the power line is a cable harness.

8. The industrial system of claim 1, wherein the industrial actuator is an industrial robot.

9. A method of controlling an industrial system, comprising:
providing an industrial system comprising:
an industrial actuator including a primary compartment containing at least one primary electric device and a secondary compartment containing at least one secondary electric device;
a pressure system configured to generate an overpressure in the primary compartment with respect to an exterior region outside of the industrial actuator, and to generate an overpressure in the secondary compartment with respect to the exterior region;
a power line adapted for supplying electric power to each primary electric device and each secondary electric device; and
a primary switch disposed along the power line and arranged to selectively connect and disconnect power supplied to each primary electric device and each secondary electric device; and
a secondary switch disposed along the power line and arranged to selectively connect and disconnect power supplied to each secondary electric device, the secondary switch being positioned inside the primary compartment;
controlling the primary switch to adopt a disconnected state;
controlling the secondary switch to adopt a disconnected state;
generating, by the pressure system and while the primary switch and the secondary switch are in the respective disconnected state, an overpressure in the primary compartment with respect to the exterior region;
controlling, after generating the overpressure in the primary compartment, the primary switch to adopt a connected state to provide power to each primary electric device;
generating, by the pressure system and while the primary switch is in the connected state, an overpressure in the secondary compartment with respect to the exterior region; and
controlling, after generating the overpressure in the secondary compartment, the secondary switch to adopt a connected state to provide power to each secondary electric device.

10. The method of claim 9, further comprising:
controlling, after generating the overpressure in the secondary compartment, the secondary switch to adopt the disconnected state; and
physically separating the secondary compartment from the primary compartment after generating the overpressure in the secondary compartment and while the secondary switch is in the disconnected state.

11. The method of claim 9, further comprising controlling one or more of the at least one primary electric devices while the primary switch is in the connected state and the secondary switch is in the disconnected state.
